(19) United States
(12) Patent Application Publication
(10) Pub. No.: US 2026/0066495 A1
(43) Pub. Date: Mar. 5, 2026

(54) ELECTRODE ASSEMBLY AND SECONDARY BATTERY INCLUDING THE ELECTRODE ASSEMBLY T

(71) Applicant: SAMSUNG SDI CO., LTD., Yongin-si (KR)

(72) Inventor: Dae-Sup Kim, Yongin-si (KR)

(21) Appl. No.: 19/019,705

(22) Filed: Jan. 14, 2025

(30) Foreign Application Priority Data
Aug. 28, 2024 (KR) 10-2024-0116042

(51) Int. Cl. H01M 50/538; H01M 10/04

(52) U.S. Cl. CPC H01M 50/538; H01M 10/0431

(57) ABSTRACT

An electrode assembly, including a first electrode including a first substrate, a first non-coated portion at an end in a longitudinal direction of the first substrate, and a first substrate tab connected to a surface of the first non-coated portion, a second electrode including a second substrate, a second non-coated portion at an end in a longitudinal direction of the second substrate, and a second substrate tab connected to a surface of the second non-coated portion, and a separator between the first electrode and the second electrode, wherein the first electrode, the separator, and the second electrode are sequentially stacked and wound, and wherein the first substrate tab and the second substrate tab are aligned in a straight line along a cross-sectional radial direction in a wound state.

### CROSS-REFERENCE TO RELATED APPLICATION

This application claims priority under 35 U.S.C. § 119 to Korean Patent Application No. 10-2024-0116042, filed in the Korean Intellectual Property Office on Aug. 28, 2024, the entire contents of which are hereby incorporated by reference.

### BACKGROUND

### 1. Field

Embodiments relate to an electrode assembly and a secondary battery including the electrode assembly.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The electrode assembly may be configured by alternately stacking electrodes consisting of an anode and a cathode, and a separator, or by winding the electrodes and the separator in a stacked state. The substrate tab connected to an electrode may be connected to an electrode terminal to function as an electrical path between the electrode assembly and the electrode terminal.

The above information disclosed in this Background section is for the enhancement of understanding of the background of the present disclosure, and therefore, it may contain information that does not constitute related (or prior) art.

### SUMMARY

Embodiments include an electrode assembly, including a first electrode including a first substrate, a first non-coated portion at an end in a longitudinal direction of the first substrate, and a first substrate tab connected to a surface of the first non-coated portion, a second electrode including a second substrate, a second non-coated portion at an end in a longitudinal direction of the second substrate, and a second substrate tab connected to a surface of the second non-coated portion, and a separator between the first electrode and the second electrode, wherein the first electrode, the separator, and the second electrode are sequentially stacked and wound, and wherein the first substrate tab and the second substrate tab are aligned in a straight line along a cross-sectional radial direction in a wound state.

The first electrode may be an anode, and the second electrode may be a cathode.

The first substrate tab and the second substrate tab may be at an outermost of a cross-sectional surface in the wound state.

The first substrate tab and the second substrate tab may be aligned along a winding-axis direction of the electrode assembly in the wound state.

The first substrate tab and the second substrate tab do not to overlap each other in the wound state.

The second substrate tab may be further than the first substrate tab from a winding center of the electrode assembly in the wound state.

The first substrate tab protrudes from the first substrate in a first direction, and the second substrate tab protrudes from the second substrate in a second direction opposite the first direction.

The first electrode may include a first area in which the first substrate tab is coupled to the first substrate, and the second electrode may include a second area in which the second substrate tab is coupled to the second substrate.

A length of the first area may be less than or equal to 50% of a width of the first substrate based on the first direction.

A length of the second area may be less than or equal to 50% of a width of the second substrate based on the second direction.

The first electrode and the second electrode may be wound to allow a center of the width of the first substrate and a center of the width of the second substrate to align with each other.

Embodiments include a secondary battery, including an electrode assembly, a case having an opening at an end, the case accommodating the electrode assembly therein, and a cap assembly coupled to a side of the case to seal the opening, wherein the electrode assembly includes a first electrode including a first substrate, a first non-coated portion at an end in a longitudinal direction of the first substrate, and a first substrate tab connected to a surface of the first non-coated portion, a second electrode including a second substrate, a second non-coated portion at an end in a longitudinal direction of the second substrate, and a second substrate tab connected to a surface of the second non-coated portion, and a separator interposed between the first electrode and the second electrode, wherein the first electrode, the separator, and the second electrode are sequentially stacked and wound, and wherein the first substrate tab and the second substrate tab are aligned in a straight line along a cross-sectional radial direction in a wound state.

The first substrate tab and the second substrate tab may be at an outermost of a cross-section in the wound state.

The first substrate tab and the second substrate tab may be aligned in a winding-axis direction of the electrode assembly in the wound state.

The first substrate tab and the second substrate tab may not overlap each other in the wound state.

The second substrate tab may be further than the first substrate tab from a winding center of the electrode assembly in the wound state.

The first substrate tab may protrude from the first substrate in a first direction, and the second substrate tab may protrude from the second substrate in a second direction opposite to the first direction.

The first substrate tab may be connected to the cap assembly.

The second substrate tab may be connected to a bottom portion of the case.

The secondary battery may be a coin cell, or a button cell.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 is a perspective view of an example of a secondary battery according to one or more embodiments;

FIG. 2 is a cross-sectional view of an example of a secondary battery according to one or more embodiments;

FIG. 3 is a cross-sectional view of an example of the secondary battery taken along line X-X′ in FIG. 2;

FIG. 4 is a perspective view of an example of an electrode assembly according to one or more embodiments;

FIG. 5 is a cross-sectional view of an example of a wound electrode assembly according to one or more embodiments;

FIG. 6 is a cross-sectional view of an example of a wound electrode assembly according to one or more embodiments;

FIG. 7 is a cross-sectional view of an example of a wound electrode assembly according to one or more embodiments;

FIG. 8 is a cross-sectional view of an example of a wound electrode assembly according to one or more embodiments;

FIG. 9 is a view of a first electrode, a separator, and a second electrode in a wound state according to one or more embodiments;

FIG. 10 is a plan view of an example of a first electrode coupled with a first substrate tab according to one or more embodiments; and

FIG. 11 is a plan view of a second electrode coupled with a second substrate tab according to one or more embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her disclosure in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

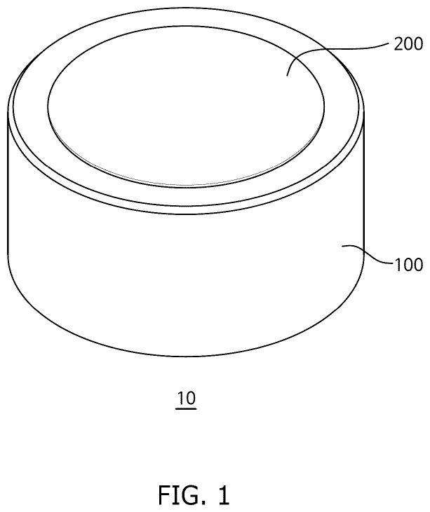

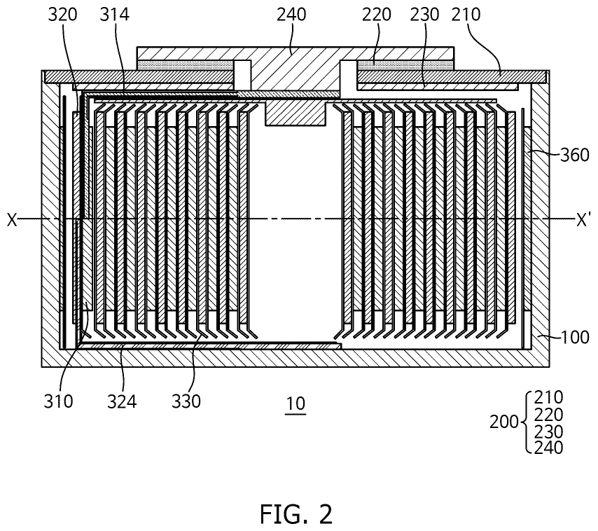

FIG. 1 is a perspective view of an example of a secondary battery according to one or more embodiments, and FIG. 2 is a cross-sectional view of an example of a secondary battery according to one or more embodiments of the present disclosure.

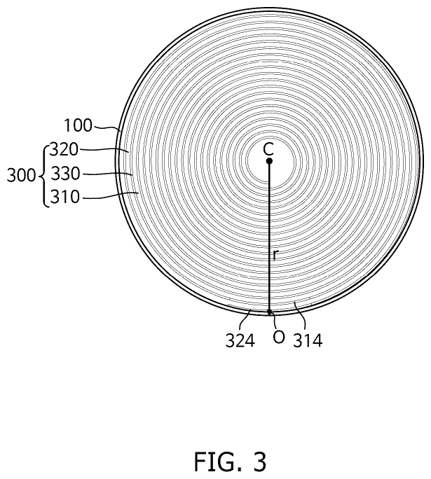

Referring to FIGS. 1 and 2, a secondary battery 10 may include a case 100, a cap assembly 200, and an electrode assembly 300 (see FIG. 3).

The secondary battery 10 may be a coin-type or button-type secondary battery. For example, the secondary battery 10 may have a cylindrical shape. However, the secondary battery 10 may have a square shape, a pouch shape, a cylinder shape battery. According to one or more embodiments, the secondary battery 10 may be a secondary battery that is chargeable and dischargeable.

The case 100 may accommodate an electrode assembly 300 and an electrolyte and form the outer shape of a secondary battery with the cap assembly 200. The case 100 may include a sidewall portion in a cylindrical shape, and a bottom portion connected to a side of the sidewall portion. However, the case 100 may have various shapes such as a cylindrical shape, a pouch shape, etc. The case 100 may be made of a metal such as stainless steel (SUS), aluminum (Al), aluminum alloy, nickel (Ni)-plated steel, or a laminate film or plastic forming the pouch.

The case 100 may accommodate the electrode assembly 300. The electrode assembly 300 may be inserted through an opening formed on one side of the case 100. The opening of the case 100 may be sealed by the cap assembly 200. By welding, the opening of the case 100 may be sealed by the cap assembly 200. The cap assembly 200 may be coupled to a side of the case 100.

The cap assembly 200 may include a cap plate 210, an insulator 220, an insulating member 230, and a terminal plate 240. The cap plate 210 may cover the opening of the case 100. The cap plate 210 may be coupled to the side surface of the case 100 corresponding to the side surface of the opening.

An inserting groove may be formed in the cap plate 210. The inserting groove may be formed in the center of the cap plate 210. The part of the terminal plate 240 (e.g., an inserting portion of the terminal plate) may be inserted into the inserting groove and the terminal plate 240 may be disposed on the cap plate 210. The terminal plate 240 may include a body portion and an inserting portion protruding from the body portion. The inserting portion of the terminal plate 240 may be inserted into the inserting portion of the cap plate 210. The inserting portion of the terminal plate 240 may be electrically connected to a first substrate tab 314 by contacting. Referring to FIG. 2, the cap assembly 200 including the terminal plate 240 may be coupled with the case 100 to allow the inserting portion to face the electrode assembly. The cap assembly 200 may be coupled with the case 100 so that the inserting portion of the terminal plate 240 may face in a direction opposite to the electrode assembly 300 (i.e. toward the upper surface of the battery), but the direction may vary.

The insulator 220 may be disposed between the terminal plate 240 and the cap plate 210. The insulator 220 may have an adhesion to combine the terminal plate 240 with the cap plate 210. The insulator 220 may be formed of an insulating material to electrically insulate between the terminal plate 240 and the cap plate 210.

The insulating member 230 may be disposed at the bottom of the cap plate 210. The upper surface of the cap plate 210 may face the body portion of the terminal plate 240, and the lower surface of the cap plate 210 may face the electrode assembly. The insulating member 230 may be formed of an insulating material to insulate between the cap plate 210 and the electrode assembly 300 or between the cap plate 210 and the first substrate tab 314.

The electrode assembly 300 may include a first electrode, a second electrode, and a separator. The electrode assembly 300 may be formed by winding a separator interposed between the first and second electrodes. The electrode assembly 300 may form a winding portion by winding, and include a through hole in the winding portion.

According to one or more embodiments, a first electrode 310 may include a first substrate, a first non-coated portion formed at a longitudinal end of the first substrate, and a first substrate tab 314 connected to a surface of the first non-coated portion. The first substrate may include a first active material layer coated with a first active material on at least one surface thereof, and a first non-coated portion disposed at the end of the first substrate with the exposed first substrate. The first substrate tab 314 may extend outwardly from the first non-coated portion of the first substrate where the active material is not coated, and the first substrate tab 314 may be electrically connected to the terminal plate 136 of the cap assembly 130.

According to one or more embodiments, a second electrode 320 may include a second substrate, a second non-coated portion formed at a longitudinal end of the second substrate, and a second substrate tab 324 connected to a surface of the second non-coated portion. The second substrate may include, on at least one surface thereof, a second active material layer where a second active material is coated and a second non-coated portion is disposed at the end of the second substrate where the second substrate is exposed. The second substrate tab 324 may extend outwardly from the second non-coated portion of the second substrate, and the second substrate tab 324 may be electrically connected to the bottom portion of the case 100.

The first electrode 310 may function as an anode. In this case, the first substrate may be formed of, for example, aluminum foil, and the first active material may include, for example, a transition metal oxide. The second electrode 320 may function as a cathode. In this case, the second substrate may be formed of, for example, copper foil or nickel foil, and the second active material may include, for example, graphite.

A separator 330 may prevent a short circuit between the first electrode 310 and the second electrode 320 while allowing the movement of lithium ions. The separator 330 may be a form of, for example, a polyethylene film, a polypropylene film, a polyethylene-polypropylene film, etc., but it is not limited thereto. The separator 330 of the electrode assembly 300 may be longer than the first electrode 310 and the second electrode 320 in the height direction of the electrode assembly 300 (in the orientation shown in FIG. 2).

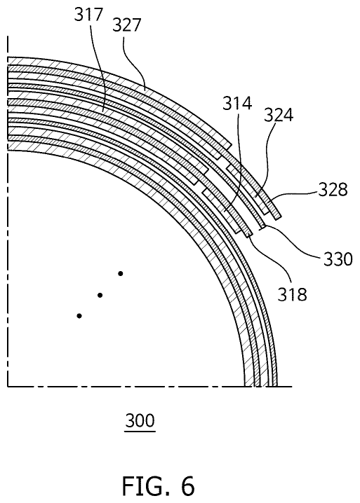

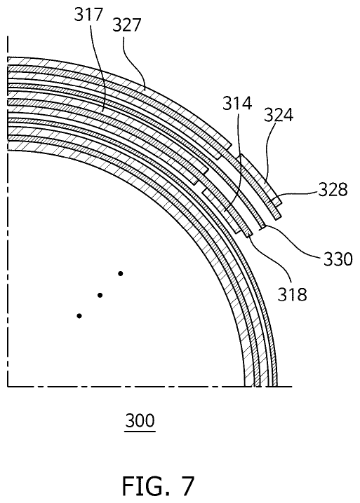

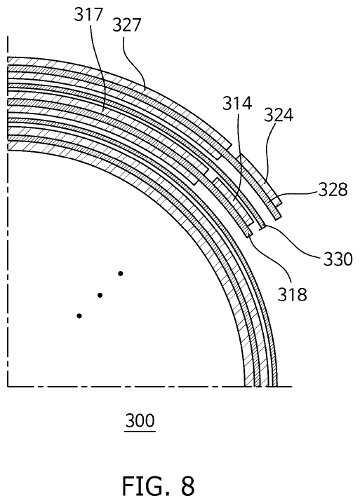

The first electrode 310, the separator 330 and the second electrode 320 may be sequentially stacked and wound, and the first substrate tab 314 and the second substrate tab 324 may be aligned in a straight line along a cross-sectional radial direction in a wound state. The first substrate tab 314 and the second substrate tab 324 may be disposed at the outermost (outermost location) of the cross-sectional surface in the wound state. The second substrate tab 324 may be further disposed from the winding center portion of the electrode assembly 300 than the first substrate tab 314 in the wound state. Therefore, the damage to the electrode that occurs because the electrode assembly 300 expands and contacts the case 100 during the charging/discharging of the secondary battery may be prevented. The description regarding the above will be detailed in FIG. 3 to FIG. 8.

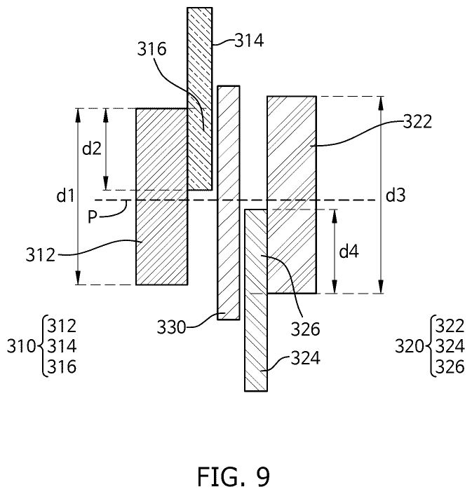

According to one or more embodiments, the first substrate tab 314 and the second substrate tab 324 may be arranged in alignment along a winding-axis direction of the electrode assembly 300 in the wound state. The first substrate tab 314 and the second substrate tab 324 may be disposed not to overlap each other in the wound state. The description regarding the above will be detailed in FIG. 9 to FIG. 11.

The first substrate tab 314 may be disposed protruding from the first substrate, and the second substrate tab 324 may be disposed to protrude from the second substrate in a direction opposite to the direction where the first substrate tab 314 protrudes. Therefore, the first substrate tab 314 may be connected to the terminal plate 240, and the second substrate tab 324 may be connected to the bottom portion of the case 100.

Each of the first substrate tab 314 and the second substrate tab 324 may be covered by a cover tape. The cover tape may include an insulating material. The insulating material may provide electrical insulation to prevent a current from flowing. Therefore, a short circuit may be prevented that occurs between the first substrate tab 314, the second substrate tab 324, and a conductive component.

The electrode assembly 300 may be accommodated inside the case 100 with an electrolyte while being wound into a cylindrical shape. The electrolyte may be an organic liquid containing a salt that is injected so that lithium ions may move between the positive and negative plates, and may include a non-aqueous organic electrolyte that is a mixture of a lithium salt such as LiPF₆, LiPF₄, LiClO₄, and a high-purity organic solvent, but the materials may vary.

FIG. 3 is a cross-sectional view of an example of a secondary battery taken along line X-X′ in FIG. 2.

Referring to FIG. 3, the cross-sectional surface of the electrode assembly 300 may be a circular shape, and an empty place including a winding center portion C may be formed in a winding process. The cross-sectional shape of the empty space including the winding center portion C may be a circular shape, but the shape may vary.

The first substrate tab 314 and the second substrate tab 324 may be aligned in a straight line along a cross-sectional radial (r) direction in a wound state. During the charging or discharging of the secondary battery, the electrode assembly 300 may expand and uniformly contact the case 100 to prevent damage to the electrode.

The first substrate tab 314 and the second substrate tab 324 may be disposed between ⅘ to 1 of a cross-sectional radius (r). The first substrate tab 314 and the second substrate tab 324 may be disposed at an outermost (location) O of the cross-sectional surface in a wound state. The outermost O of the cross-sectional surface may indicate a last winding turn of the wound electrode assembly.

The second substrate tab 324 may be further disposed from the winding center C of the electrode assembly 300 than the first substrate tab 314 in the wound state. The second substrate tab 324 may be wound to be closer to the outermost O than the first substrate tab 314.

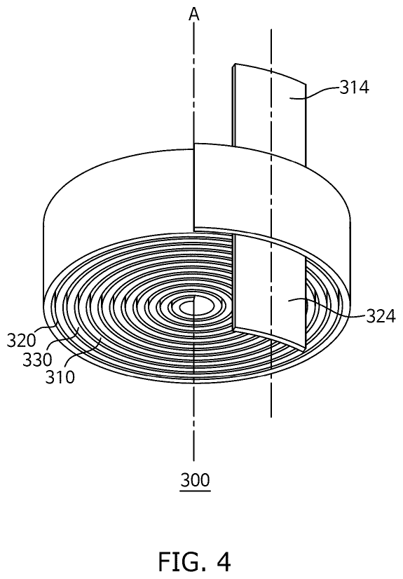

FIG. 4 is a perspective view of an example of an electrode assembly according to one or more embodiments.

Referring to FIG. 4, the electrode assembly 300 may be formed by winding the first electrode 310, the second electrode 320, and a separator 330 interposed between the first electrode 310 and the second electrode 320.

Each of the first electrode 310 and the second electrode 320 may include the first substrate tab 314 and the second substrate tab 324. According to one or more embodiments, the first substrate tab 314 and the second substrate tab 324 may be disposed at the outermost of the cross-sectional surface in the wound state.

The first substrate tab 314 and the second substrate tab 324 may be arranged in alignment along a winding-axis direction A of the electrode assembly 300 in the wound state. The first substrate tab 314 and the second substrate tab 324 may be disposed so that a line (virtual line) parallel to the winding-axis direction A of the electrode assembly 300 may be disposed at the center of each of the first substrate tab 314 and the second substrate tab 324.

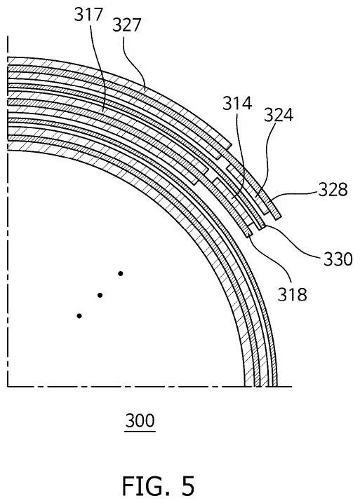

FIG. 5 to FIG. 8 are cross-sectional views of an example of a wound electrode assembly according to one or more embodiments.

Referring to FIG. 5 to FIG. 8, the electrode assembly 300 may include the first electrode 310, the second electrode 320 and the separator 330. The first electrode 310 may include a first active material layer 317, a first non-coated portion 318 and a first substrate tab 314. The second electrode 320 may include a second active material layer 327, a second non-coated layer 328 and a second substrate tab 324.

The first substrate tab 314 and the second substrate tab 324 may be disposed at the outermost of the cross-sectional surface in the wound state. The first substrate tab 314 and the second substrate tab 324 may be opposite to each other with the separator 330 disposed therebetween in the wound electrode assembly 300, but other arrangements are possible. The first substrate tab 314 and the second substrate tab 324 may be disposed on the same surface of the wound first electrode 310 and the second electrode 320, respectively, or may be disposed on opposite surfaces of the first electrode 310 and the second electrode 320.

The opposite surface may be a surface equally facing the outermost side, or the winding center in the wound electrode assembly 300. The opposite surface may be formed on the surface where the second substrate tab 324 faces the winding center portion when the first substrate tab 314 is formed on the surface toward the outermost side in the wound electrode assembly 300. The surfaces to which the first substrate tab 314 and the second substrate tab 324 are attached are not limited in both surfaces of the first electrode 310 and the second electrode 320.

FIG. 9 is a view of a first electrode, a separator, and a second electrode in a wound state according to one or more embodiments.

Referring to FIG. 9, the first electrode 310 connected to the first substrate tab 314, the separator 330 and the second electrode 320 connected to the second substrate tab 324 may be stacked and wound. The first substrate tab 314 and the second substrate tab 324 may be disposed to be opposite to each other with the separator 330 disposed therebetween.

According to one or more embodiments, the first substrate tab 314 and the second substrate tab 324 may be arranged in alignment along the winding-axis direction of the electrode assembly 300 in the wound state. FIG. 9 illustrates that the first substrate tab 314 and the second substrate tab 324 are spaced apart from each other with the separator 330 disposed therebetween, but it is for convenience of explanation. During winding, in practice, the first substrate tab 314 and the second substrate tab 324 may be arranged in alignment along the winding axis direction of the electrode assembly 300 by contacting or pressurizing the separator 330.

The first substrate tab 314 may be disposed protruding from a first substrate 312, and the second substrate tab 324 may be disposed protruding in a direction opposite to the direction where the first substrate tab 314 protrudes from a second substrate 322. The first substrate tab 314 may be welded and coupled to the first substrate 312, and may protrude toward the upper side of the electrode assembly 300 by a predetermined length. The second substrate tab 324 may be welded and coupled to the second substrate 322, and may protrude to the lower side (in the orientation shown) of the electrode assembly 300 by a predetermined length. However, the protruding directions of the first substrate tab 314 and the second substrate tab 324 may be modified as needed. For example, the second substrate tab 324 may protrude to the lower side of the electrode assembly, the second substrate tab 324 may protrude to the upper side of the electrode assembly, or the first substrate tab 314 and the second substrate tab 324 may protrude in the same direction.

The first substrate tab 314 and the second substrate tab 324 may be disposed not to overlap each other. The lower part of the first substrate tab 314 and the upper part of the second substrate tab 324 may be arranged in alignment along the winding-axis direction of the electrode assembly 300. The decrease in a winding coiling rate may be prevented that occurs when the first substrate tab 314 and the second substrate tab 324 are thicker than the first electrode 310 and the second electrode 320 overlap each other in the winding-axis direction.

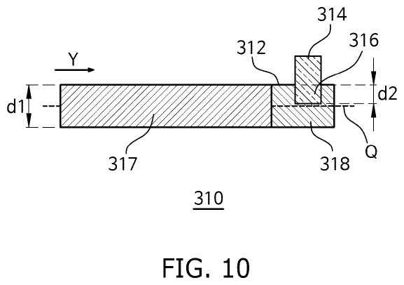

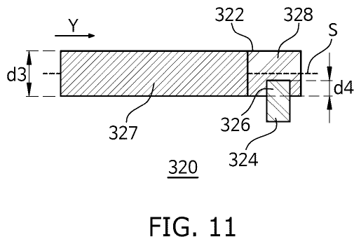

The first electrode 310 and the second electrode 320 may be wound so that the center of the first substrate 312 (Q, referring to FIG. 10) corresponds to the center (S, referring to FIG. 11) of the second substrate 322. As shown in FIG. 9, the center of the width of the first substrate 312 and the center of the width of the second substrate 322 may be stacked and wound to form a virtual center line Q.

FIG. 10 is a plan view of an example of the first electrode coupled to the first substrate tab. FIG. 10 is a plan view of before the electrode assembly of the secondary battery is wound.

Referring to FIG. 10, the first electrode 310 may include a first substrate, a first non-coated portion formed at the end in the longitudinal direction of the first substrate, and the first substrate tab 314 connected to a surface of the first non-coated portion. The first electrode 310 may include the first active material layer 317 coated with a first active material. It may be wound from left to right (Y direction of FIG. 10) based on the drawing direction of FIG. 10. From the below, the Y direction is referred to as a winding direction, and based on the drawing direction of FIG. 10, the left end of the first electrode 310 may indicate the winding leading end, and the right end may indicate the winding terminal end.

The winding leading end may refer to an area where winding begins during the winding process of the electrode assembly 300, and the winding terminal end may refer to an area where winding ends during the winding process of the electrode assembly 300. Accordingly, the first substrate tab 314 of the winding terminal end may be located at the outer periphery of the wound electrode assembly 300. The winding terminal end may be located at the outermost side of the electrode assembly 300.

In the first electrode 310, a first non-coated portion 318 where the first substrate 312 without the first active material layer 317 is exposed may be formed on the first substrate 312, and the first substrate tab 314 may be coupled to the first non-coated portion 318. Based on a winding direction Y, the length of the first non-coated portion 318 may be greater than that of the first substrate tab 314. Therefore, although the first substrate tab 314 is coupled, part of the first substrate 312 may be exposed.

The first electrode 310 may include a first area 316 in which the first substrate tab 314 is coupled to the first substrate 312. The first area 316 may indicate an area in which the first substrate tab 314 overlaps the first substrate 312.

Based on the direction in which the first substrate tab 314 protrudes, a length d2 of the first area 316 may be smaller than or the same as (e.g., less than or equal to) 50% of a width d1 of the first substrate 312. Therefore, the first substrate tab 314 may be coupled to be higher than a center Q of the width of the first substrate 312.

FIG. 11 is an exemplary plan view of a second electrode coupled to a second substrate tab. FIG. 11 is a plan view of before an electrode assembly of a secondary battery is wound. The duplicated description from FIG. 10 will be omitted in FIG. 11.

Referring to FIG. 11, a second electrode 320 may include a second substrate, a second non-coated portion formed on an end of a longitudinal direction of the second substrate, and a second substrate tab 324 connected to a surface of the second non-coated portion. The second electrode 320 may include the second active material layer 327 on which a second active material is coated. Based on the direction of FIG. 11, the left end of the second electrode 320 may indicate a winding leading end, and the right end may indicate a winding terminal end.

The winding leading end may indicate an area where the winding begins during the winding process of the electrode assembly 300, and the winding terminal end may indicate an area where the winding ends during the winding process of the electrode assembly 300. Therefore, the second substrate tab 324 of the winding terminal end may be arranged at the outer periphery of the wound electrode assembly 300. The winding terminal end may be arranged at the outermost of the electrode assembly 300.

The second electrode 320 may include a second area 326 in which the second substrate tab 324 is coupled to the second substrate 322. The second area 326 may indicate an area in which the second substrate tab 324 overlaps the second substrate 322.

Based on the direction in which the second substrate tab 324 protrudes, a length d4 of the second area 326 may be smaller than or the same as 50% of a width d3 of the second substrate 322. Therefore, the second substrate tab 324 may be coupled to be lower than a center S of the width of the second substrate 322.

During the charging/discharging of the secondary battery, the electrode assembly may contract or expand to contact a case that accommodates the electrode assembly. The performance and safety of the secondary battery may become an issue because the pressure between the electrode connected to the substrate tab and the case may increase, or a collision or a friction may occur, which damages the electrode.

According to partial embodiments, the present disclosure seeks to provide an electrode assembly that prevents damage to an electrode and a secondary battery including the same.

According to partial embodiments, when the electrode assembly expands during the charging and discharging of the secondary battery, the present disclosure may provide an electrode assembly that uniformly contacts the case of a secondary battery and a secondary battery including the same.

According to partial embodiments, an anode tab and a cathode tab may be aligned in a straight line along a cross-sectional radial direction of the wound electrode assembly without an empty space between the anode tab and the cathode tab, thereby preventing the crack of an electrode.

According to partial embodiments, the lower part of the anode tab and the upper part of the cathode tab may be arranged in alignment along a winding-axis direction of the electrode assembly not to overlap each other to prevent a decrease in the winding coiling rate of the electrode assembly.

Although the present disclosure has been described above with respect to embodiments thereof, the present disclosure is not limited thereto. Various modifications and variations can be made thereto by those skilled in the art within the spirit of the present disclosure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### EXPLANATION OF SOME REFERENCE SYMBOLS

10: Secondary Battery
100: Case
200: Cap Assembly 200
300: Electrode Assembly 300
310: First Electrode
312: First Substrate
314: First Substrate Tab
316: First Area
317: First Active Material Layer
318: First Non-Coated Portion
320: Second Electrode
322: Second Substrate
324: Second Substrate Tab
326: Second Area
327: Second Active Material Layer
328: Second Non-Coated Portion
330: Separator

What is claimed is:

1. An electrode assembly, comprising:
a first electrode comprising a first substrate, a first non-coated portion at an end in a longitudinal direction of the first substrate, and a first substrate tab connected to a surface of the first non-coated portion;
a second electrode comprising a second substrate, a second non-coated portion at an end in a longitudinal direction of the second substrate, and a second substrate tab connected to a surface of the second non-coated portion; and
a separator between the first electrode and the second electrode,
wherein the first electrode, the separator, and the second electrode are sequentially stacked and wound, and
wherein the first substrate tab and the second substrate tab are aligned in a straight line along a cross-sectional radial direction in a wound state.

2. The electrode assembly as claimed in claim 1, wherein the first electrode is an anode, and the second electrode is a cathode.

3. The electrode assembly as claimed in claim 1, wherein the first substrate tab and the second substrate tab are at an outermost of a cross-sectional surface in the wound state.

4. The electrode assembly as claimed in claim 1, wherein the first substrate tab and the second substrate tab are aligned along a winding-axis direction of the electrode assembly in the wound state.

5. The electrode assembly as claimed in claim 4, wherein the first substrate tab and the second substrate tab do not to overlap each other in the wound state.

6. The electrode assembly as claimed in claim 1, wherein the second substrate tab is further than the first substrate tab from a winding center of the electrode assembly in the wound state.

7. The electrode assembly as claimed in claim 1, wherein:
the first substrate tab protrudes from the first substrate in a first direction, and
the second substrate tab protrudes from the second substrate in a second direction opposite the first direction.

8. The electrode assembly as claimed in claim 7, wherein:
the first electrode comprises a first area in which the first substrate tab is coupled to the first substrate, and
the second electrode comprises a second area in which the second substrate tab is coupled to the second substrate.

9. The electrode assembly as claimed in claim 8, wherein a length of the first area is less than or equal to 50% of a width of the first substrate based on the first direction.

10. The electrode assembly as claimed in claim 9, wherein a length of the second area is less than or equal to 50% of a width of the second substrate based on the second direction.

11. The electrode assembly as claimed in claim 10, wherein the first electrode and the second electrode are wound to allow a center of the width of the first substrate and a center of the width of the second substrate to align with each other.

12. A secondary battery, comprising:
an electrode assembly;
a case having an opening at an end, the case accommodating the electrode assembly therein; and
a cap assembly coupled to a side of the case to seal the opening, wherein the electrode assembly comprises a first electrode comprising a first substrate, a first non-coated portion at an end in a longitudinal direction of the first substrate, and a first substrate tab connected to a surface of the first non-coated portion, a second electrode comprising a second substrate, a second non-coated portion at an end in a longitudinal direction of the second substrate, and a second substrate tab connected to a surface of the second non-coated portion, and a separator interposed between the first electrode and the second electrode,
wherein the first electrode, the separator, and the second electrode are sequentially stacked and wound, and
wherein the first substrate tab and the second substrate tab are aligned in a straight line along a cross-sectional radial direction in a wound state.

13. The secondary battery as claimed in claim 12, wherein the first substrate tab and the second substrate tab are at an outermost of a cross-section in the wound state.

14. The secondary battery as claimed in claim 12, wherein the first substrate tab and the second substrate tab are aligned in a winding-axis direction of the electrode assembly in the wound state.

15. The secondary battery as claimed in claim 14, wherein the first substrate tab and the second substrate tab do not overlap each other in the wound state.

16. The secondary battery as claimed in claim 12, wherein the second substrate tab is further than the first substrate tab from a winding center of the electrode assembly in the wound state.

17. The secondary battery as claimed in claim 12, wherein:
the first substrate tab protrudes from the first substrate in a first direction, and
the second substrate tab protrudes from the second substrate in a second direction opposite to the first direction.

18. The secondary battery as claimed in claim 12, wherein the first substrate tab is connected to the cap assembly.

19. The secondary battery as claimed in claim 12, wherein the second substrate tab is connected to a bottom portion of the case.

20. The secondary battery as claimed in claim 12, wherein the secondary battery comprises a coin cell, or a button cell.
